(19) United States
(12) Patent Application Publication
(10) Pub. No.: US 2007/0256338 A1
(43) Pub. Date: Nov. 8, 2007

(54) Multimedia greeting card and method of assembly

(76) Inventor: David Bawarsky, Fort Lauderdale, FL (US)

Correspondence Address: BRINKLE Y, MORGAN, SOLOMON, TATUM, STANLEY, LUNNY,;& CROSBY, LLP, 200 E. LAS OLAS BLVD, SUITE 1900, FORT LAUDERDALE, FL, 33301, US

(21) Appl. No.: 11/429,852

(22) Filed: May 8, 2006

(51) Int. Cl. G09F 1/00

(52) U.S. Cl. 40/124.06

(57) ABSTRACT

The Invention is directed to a multimedia greeting card which comprises a housing made up of a first panel hingedly connected to a second panel, A DVD or other storage device embodying one or more selected media content removably connected to one of the panels, a themed outer cover/sleeve over the housing covering at least a portion of the exterior of the housing, and one or more areas, or “fields”, associated with the housing in which one or more verbal greetings or messages, and/or photograph or other images, may be displayed. The theme may relate to any field of interest, such as birthdays, anniversaries, Valentine's Day, Christmas, etc. The preferred embodiment of the invention is also directed to the process for making multiple versions of a multimedia greeting card.

### FIELD OF THE INVENTION

This invention relates to greeting cards marketed and sold through electronic commerce, in general, and, more specifically, to a system which permits the consumer to select, customize, and attach entertainment programs on DVD such as a feature length movies, concerts, television programs, documentaries, etc. to a greeting card, and to coordinate delivery of such greeting card, the card being purchased over one or more computer networks, via catalog and/or retail kiosk.

### BACKGROUND OF THE INVENTION

The World Wide Web and the Internet, in general, have created a completely new venue in which to obtain information, purchase goods and services and interact with other network users. Accordingly, many sources of products and services have established websites containing information about products, services and available information. A number of commercially available software applications, e.g. web browsers, executable on a conventional computer architecture enable users to connect to the Internet and provide a graphic user interface and appropriate functionality for locating and exploring “websites”. Examples of such commercially available browsers include Netscape Navigator and Internet Explorer, commercially available from Microsoft Corporation, Redmond, Wash. Websites typically comprise a server operatively coupled to the Internet, the server having one or more “pages” which may be explored by a user using the web browser application.

Using a web browser, computer shoppers have the ability to access and purchase products and services from far reaching locations, including international locations. In order to purchase a product, the shopper accesses the website server of a vendor, selects a product, provides payment, typically in the form of credit card information, and provides delivery instructions to the vendor.

The purchase of goods and services over the Internet, referred to hereafter as “eCommerce”, has become very popular recently. It has also become very popular to purchase feature length DVD movies to give as gifts. In the brick and mortar world, when giving DVD movies as a gift, a person typically purchases the DVD movie from a merchandise retailer. In addition, the person may purchase a greeting card to help express his or her thoughts about the DVD movie or the occasion. Such greeting cards usually contain personal, handwritten messages and are handed along with the DVD movie gift for simultaneous presentation to the recipient.

It is possible to purchase a movie/entertainment DVDs as gifts from the websites of eCommerce vendors and have them sent to a recipient's address. It is also possible to purchase greeting cards and custom greeting cards over the Internet to be delivered to the recipient's postal address.

However, no known service or facility exists which enables an eCommerce shopper to purchase a feature length movie/entertainment DVD over the Internet and concurrently select and personalize a greeting card to be packaged together as one gift/greeting card. Some companies create custom greeting cards that include a gift card or a mini-disc multimedia greeting. Adding a feature length movie attached to the greeting card enhances and expands the greeting card theme, by allowing the eCommerce shopper to select a movie DVD tied to the card theme. For example; Christmas greeting card might include a “Christmas Themed” DVD movie, e.g. “It's a Wonderful Life”, “Jingle All the Way”. It also increases the monetary value of the greeting card.

In addition, current on-line electronic greeting card services, such as those offered by Hallmark or American Greetings Corporation, enable users to select a card and customize the card by entering text into a dialog box via the webserver graphic user interface. However, such services do not enable the user to add feature length DVD movie and other entertainment DVDs to the card.

A need exists, therefore, for technology which permits a person to purchase a feature length movie/entertainment DVD from either an Internet website, catalog, and/or retail kiosk, then choose a retail quality greeting card, personalize the greeting card, attach a DVD, and send it as a gift to a recipient.

### SUMMARY OF THE INVENTION

The present invention discloses a method, system and apparatus for enabling the selection, customization, and transmission of greeting cards and attaching a feature length movie/entertainment DVD thereto. In one embodiment of the invention, an eCommerce shopper (network user) connects to the inventive system. The network user may select from any of a number of card designs stored in a vendor's database. The cards are presented to the network user in a WYSIWYG format. The user is able to customize the card in any one or more of a number of ways, such as by adding a verse, photograph, closing greeting, and/or font style, and to review and make changes. After purchase, the card is printed by the inventive system, the DVD is attached to the card and mailed to the address of a recipient, as specified by the network user.

In a second implementation of the invention, following purchase of the card, the card is transmitted to a distribution center of an eCommerce vendor from whom a gift has been purchased. There the card is printed, and the DVD is attached and shipped to the recipient, as specified by the network user. In this implementation, a network user connects with the website of an eCommerce vendor and personalizes and then purchases a greeting card in accordance with the invention. After purchasing the card, the data and data structures representing the customized card, as well as data defining the purchaser, recipient(s), and selected DVD title, are transmitted over a computer network to the distribution center of the eCommerce vendor. The card is printed at the eCommerce vendor's distribution center, preferably on a high-resolution graphics printer, and the DVD is attached and delivered/shipped as a gift to the recipient. In this manner, the recipient receives the DVD title attached inside the greeting card.

According to a third implementation of the present invention, a method, system and apparatus enables a person to: 1) purchase the right to choose and customize a multimedia greeting card multimedia greeting card multimedia greeting card from either an internet website, catalog, and/or retail kiosk, 2) choose a retail quality greeting card to incorporate into the multimedia greeting card, 3) personalize the greeting card using the WYSIWIG personalization technology described herein, 4) choose a feature length movie/entertainment DVD and 5) send the card and movie as a gift to the recipient.

According to one aspect of the present invention, in a computer system connectable to a computer network, a method and computer program code comprise: (a) maintaining in memory a compilation of greeting card designs, verses and feature length DVD titles; (b) maintaining in memory data identifying each of the greeting card designs, verses, closing greetings, photos and/or any user defined modifications thereto chosen by a customer; (c) maintaining in memory data associating each customer with any greeting card design(s), verse(s), closing greeting(s), photo(s) and/or any user defined modification(s) made by that customer along with the identification of all DVD title(s) selected by that customer; (d) printing on demand a personalized greeting card comprising the identified greeting card design, verse, closing greeting and/or photo in conjunction with the user's defined modifications thereto, if any, and greeting card data reference thereon; (e) attaching the selected feature length movie/entertainment DVD to the greeting card; and (f) sending the greeting card with attached DVD to the recipient identified by the customer.

### BRIEF DESCRIPTION OF THE DRAWINGS

FIG. 1 is a front elevational illustration of the greeting card product of this invention.

FIG. 2 is a front elevational illustration of the outside of the front and back panels of the greeting card product.

FIG. 3 is a front elevational illustration of the inside of the front and back panels of the greeting card product.

FIG. 4 is a screen capture of the graphic user interface of the inventive server illustrating the starting process for the network user to create a custom movie greeting card.

FIG. 5 is a screen capture of the graphic user interface of the inventive server illustrating representative available selections of card categories, i.e. Christmas, Birthday, Mother's day, etc.

FIG. 6 is a screen capture of the graphic user interface of the inventive server illustrating representative available card design selections within a card category.

FIG. 7 is a screen capture of the graphic user interface of the inventive server illustrating the selected card design.

FIG. 8 is a screen capture of the graphic user interface of the inventive server illustrating representative available selections of verse categories, i.e. Christmas, Birthday, Mother's day, etc.

FIG. 9 is a screen capture of the graphic user interface of the inventive server illustrating representative available verse selections within a verse category.

FIG. 10 is a screen capture of the graphic user interface of the inventive server illustrating the verse selected by the user.

FIG. 11 is a screen capture of the graphic user interface of the inventive server illustrating representative available movie/entertainment DVD (genres) categories.

FIG. 12 is a screen capture of the graphic user interface of the inventive server illustrating representative available DVD title selection choices.

FIG. 13 is a screen capture of the graphic user interface of the inventive server illustrating the DVD title selected by the user.

FIGS. 14-18 are screen captures of the graphic user interface of the inventive server illustrating various representative personalization dialog screens through which a network user may customize a product.

FIG. 19 is a screen capture of the graphic user interface of the inventive server illustrating the completed personalized movie greeting card in the shopping cart.

### DETAILED DESCRIPTION

The Invention is directed to, in a preferred embodiment, a multimedia greeting card which comprises a housing made up of a first panel hingedly connected to a second panel, media content stored on a DVD removably connected to one of the panels, a themed outer cover/sleeve over the housing covering at least a portion of the exterior of the housing, and one or more areas, or “fields”, associated with the housing in which one or more verbal greetings or messages, and/or photograph or other images, may be displayed. The theme may relate to any field of interest, such as birthdays, anniversaries, Valentine's Day, Christmas, etc.

The preferred embodiment of the invention is also directed to the process for making multiple versions of a multimedia greeting card. The general steps are:
1. Providing, over a communications network, a plurality of general card theme (e.g. birthday, Valentine's Day, etc.) choices to a consumer;
2. Receiving a selection of one of the themes from the consumer;
3. Providing a plurality of thematic graphic choices to the consumer relating to the general theme chosen by the consumer;
4. Receiving a selection of one of the thematic graphic choices from the consumer;
5. Providing a list of media content choices stored on DVD to the consumer;
6. Receiving one or more selections of media content from the consumer;
7. Providing a list of textual message choices, including an option for creating a custom message;
8. Receiving a selection of a text message from the consumer
9. Providing a list of verse choices to the consumer;
10. Receiving a selection of a verse from the consumer;
11. Providing a list of photographic/graphical image choices to the consumer;
12. Receiving a selection of a photographic/graphic image from the consumer;
13. Assembling the selected thematic graphic matter onto an outer cover/sleeve of the housing, the selected media content DVD onto a DVD disc holder associated with one of the housing panels, and the textual and/or photographic/graphical matter (if included) into a completed multimedia greeting card product;
14. Delivering the completed multimedia greeting card to the consumer or a recipient designated by the consumer.

It is to be understood that the invention may employ any one or more of the above described steps, such that a greeting card contemplated by this invention may include only graphic theme subject matter on the outer cover and a DVD containing the selected media content, or the greeting card may be created using any other combination of the above described steps.

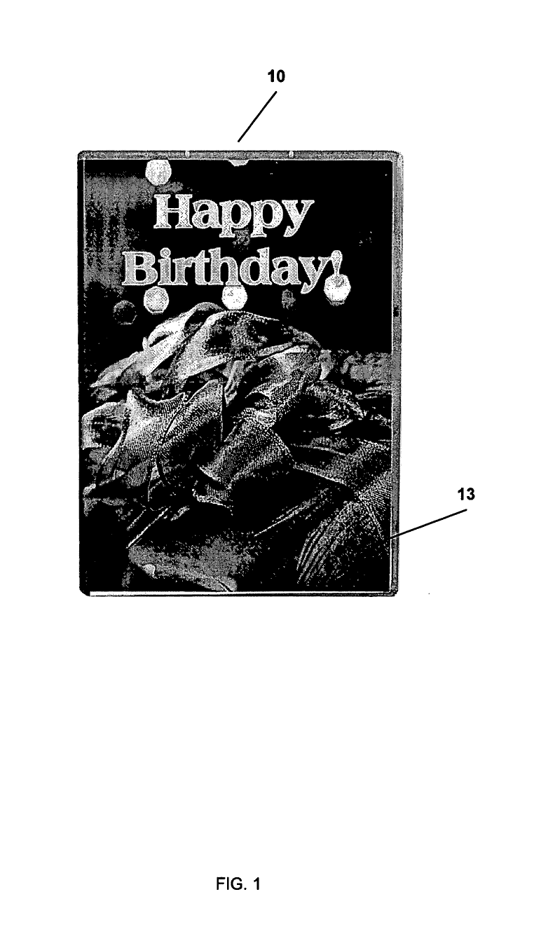

FIG. 1 is a diagrammatic representation of the preferred embodiment of the front of the movie greeting card 10. The greeting card 10 is preferably in the form of a slimline DVD case modified in accordance with this invention, which are commonly made of thin clear plastic, 7 mm thick, although it may be any thickness, and not limited to clear plastic inasmuch as it may be made of any suitable material whatsoever. For example, the entire greeting card can be printed on card stock, without using clear plastic.

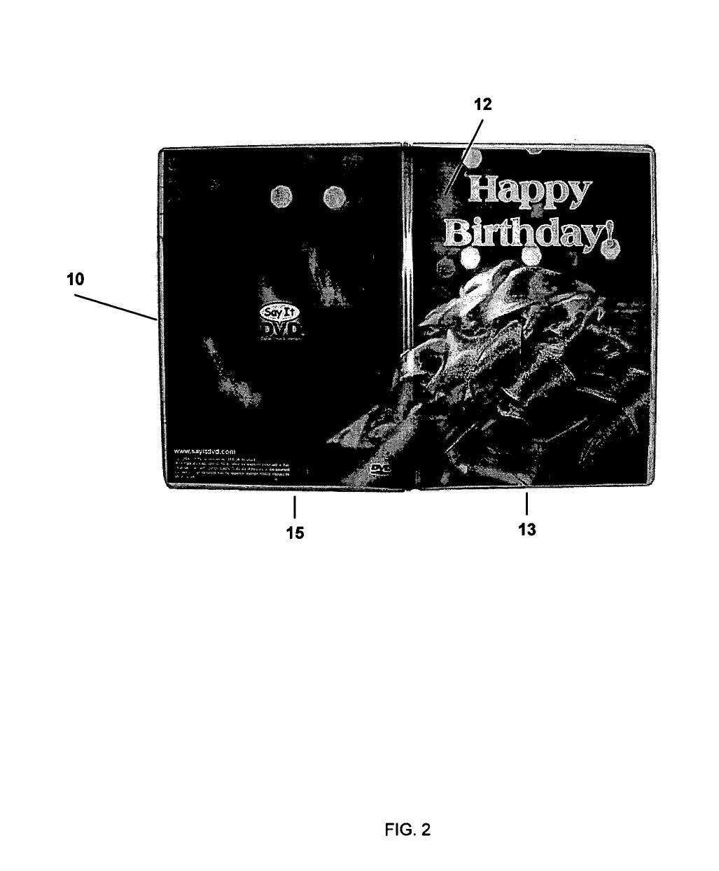

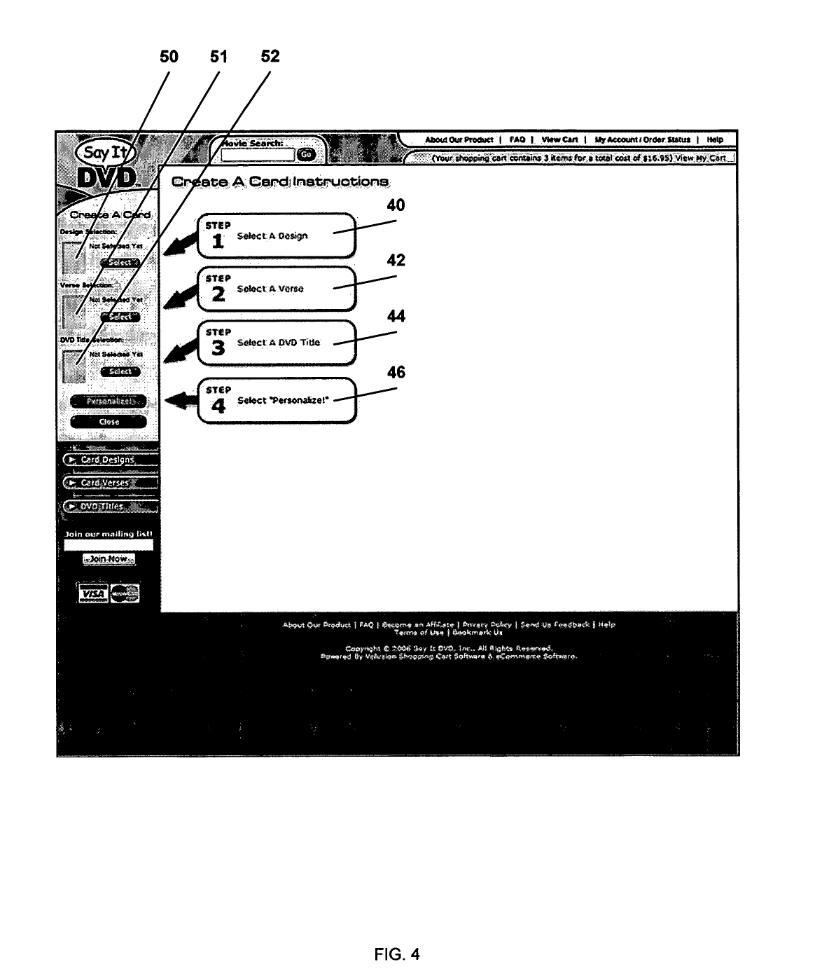

FIG. 2 is an illustration of the greeting card 10 showing the front panel 13 and back panel 15 of the greeting card. A network user selects the greeting card cover design 12 from a database of card designs in a vendor's database using a graphical user interface such as that shown in FIG. 4. The network user's selected card cover design 12 and other personalized information is printed and inserted into a thin plastic overlay 13, which resides on top of the front panel 13 and back panel 15. However, the printed card design 12 does not have to be inserted into a plastic overlay 13, but instead could be printed on card stock and not have a plastic overlay 13 attached.

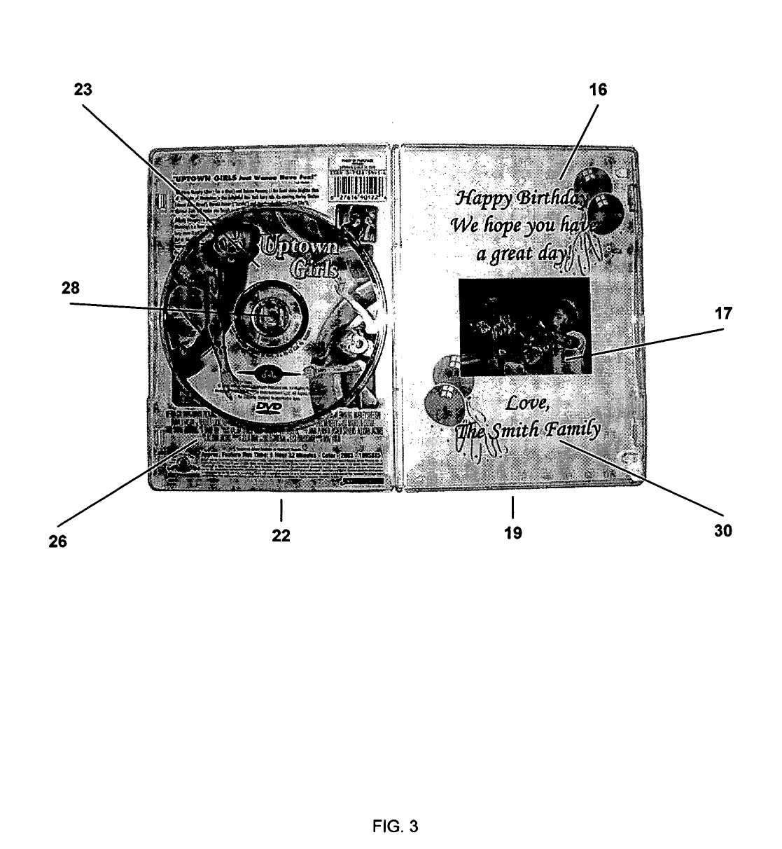

FIG. 3 is an illustration of the inside of the greeting card 10 consisting of the inside left panel 22 and inside right panel 19. The network user selects from a vendor's database: a feature length movie/entertainment title 23, card verse 16 and a closing greeting 30. The network user can also upload a photo 17 to be printed on the greeting card. The network user can either select a verse 16 from a list of verses in a vendor's database or network user can custom write their own verse 16.

The printed DVD program information sheet 26 associated with the selected feature length DVD is inserted into inside left panel 22 and the DVD is attached to a locking DVD hub 28 placed in front of the program's printed information sheet 26. However, is not limited to the inside left panel 22, for example the DVD title 23 and the title's printed information sheet 26 can also be mounted on the inside right panel 19 with a DVD locking hub 28, in which case the verse 16, photo 17 and closing greeting 20 would be placed on the inside left panel 22.

FIGS. 4-12 are screen captures of the graphic user interface of the inventive server illustrating the create-a-card wizard allowing the network user to create a custom feature length movie greeting card in accordance with the present invention. The network user makes selections using a computer or kiosk connectable to a communications network, and employs a method and computer program product containing program code comprising: (a) maintaining in memory a compilation of greeting card designs, verses, closing greetings and DVD titles; (b) maintaining in memory data identifying of the greeting card design(s), verse(s) and closing greeting(s) and any user defined modifications thereto associated with the user; (c) maintaining in memory data associating said greeting card design, verse and closing greeting and any user defined modifications along with a user selected DVD title; (d) printing on demand a personalized greeting card comprising the identified greeting card design, verse, photo and closing greeting in conjunction with the user's defined modifications thereto and greeting card data reference thereon; and (e) attaching a feature length DVD movie or other entertainment program selected by the user to the inside of greeting card.

The network user has four steps to take to create a feature length movie greeting card; FIG. 4 illustrates the beginning process of the four steps in creating a card by selecting (a) card design 40, (b) verse 42, (c) DVD title 44 and (d) personalization 46 of the greeting card from a vendor's database. When each item is ultimately selected, a thumbnail illustration of each selection is placed into the thumbnail area 50, 51, 52 of create-a-card wizard in accordance with the present invention.

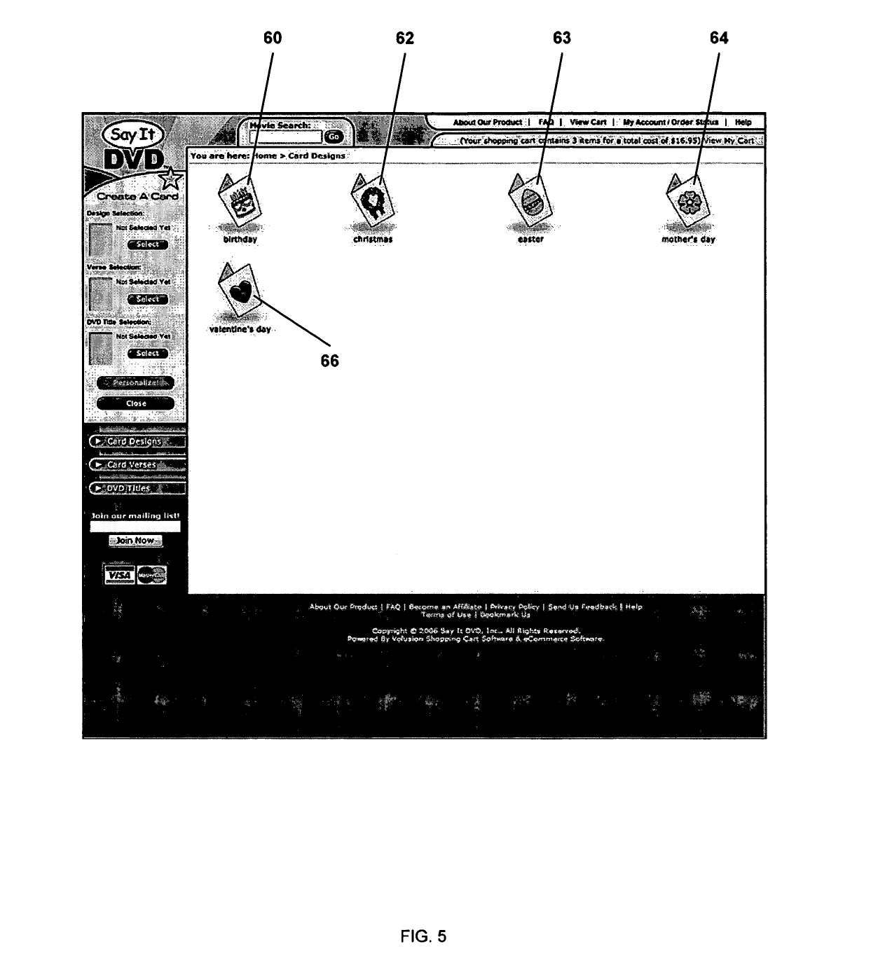

The network user selects a card category, as shown in FIG. 5, from a category of card categories (genres), i.e. Birthday 60, Christmas 62, Easter 63, Mother's Day 64 or Valentine's Day 66. However, there is no limit to the number of theme categories in the vendor's database.

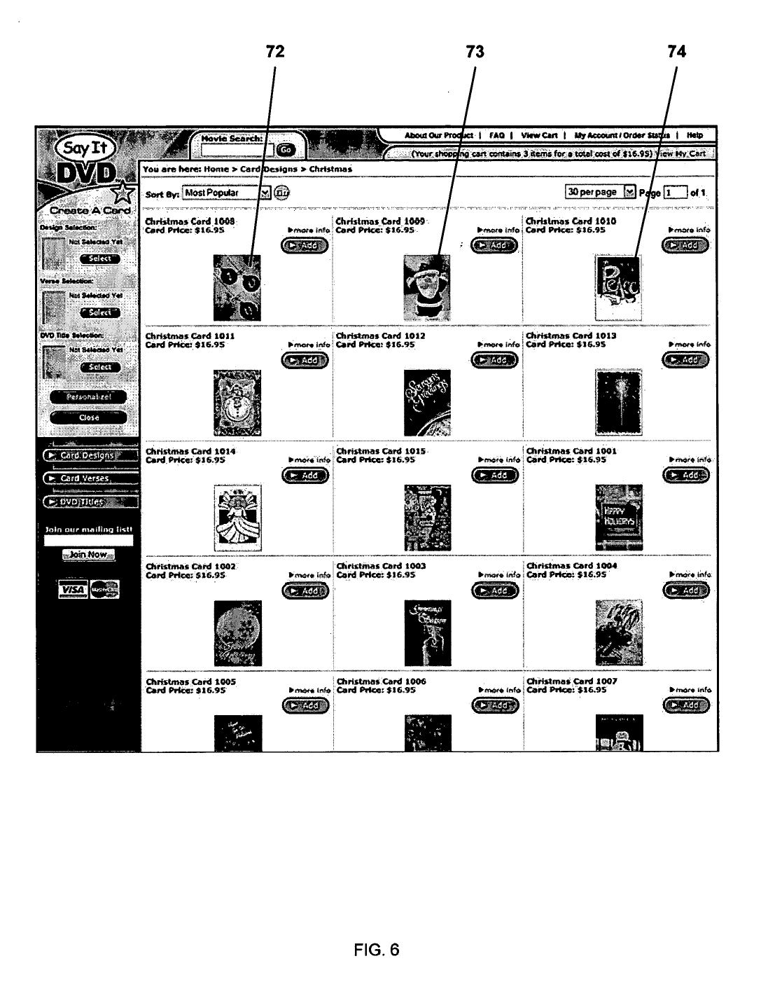

When a card theme is selected, as shown in FIG. 6, the user selects a card design, e.g. 72, 73, 74 from a listing of card designs for that category. There is no limit to the number of card designs in the vendor's database.

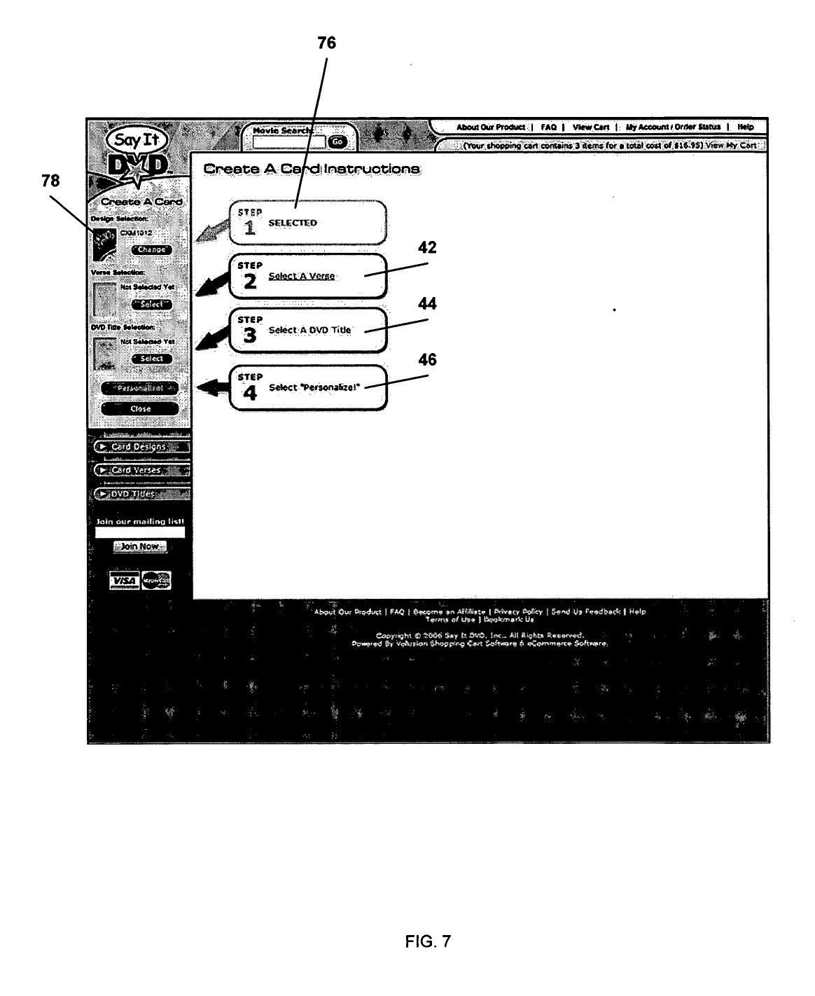

After the network user selects a card design, a thumbnail of the card design, as shown in FIG. 7, is placed in the design selection slot 78 of the create-a-card wizard and is indicated as being selected at 76. The next step is for the user to select a verse by clicking on tab 42.

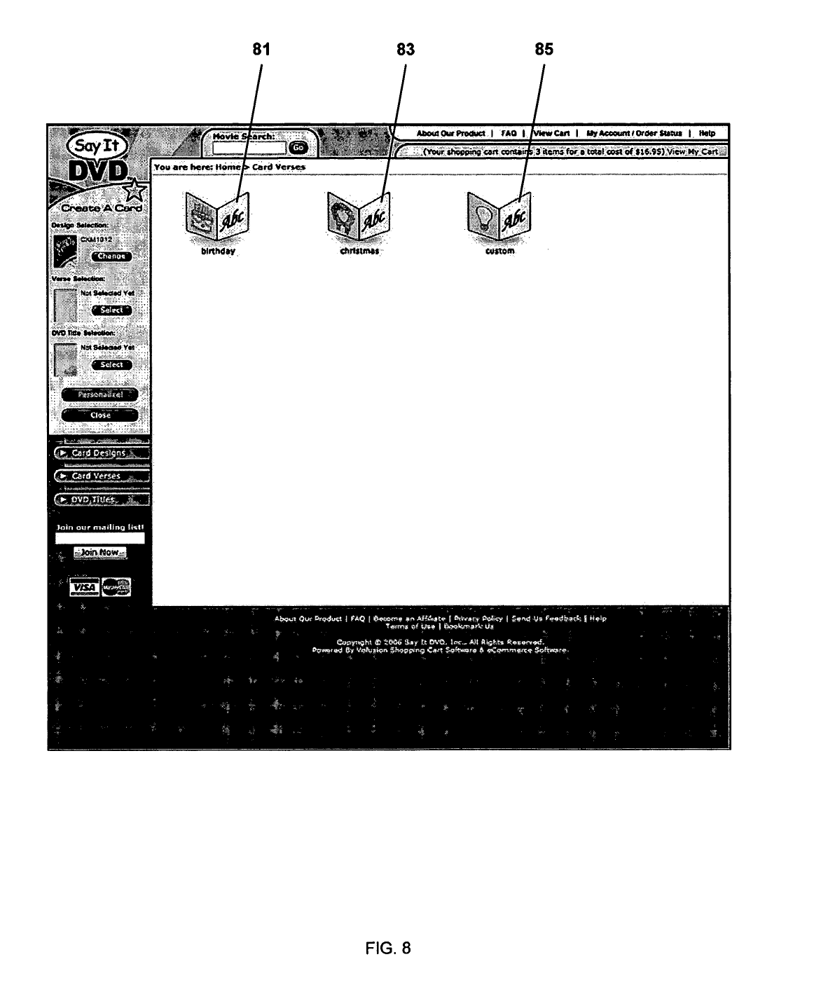

The network user selects a verse from a vendor's database of verse categories (themes), as shown in FIG. 8, e.g. Birthday 81, Christmas 83, custom write verse 85, etc. However, there is no limited to the number of verse categories in the vendor's database.

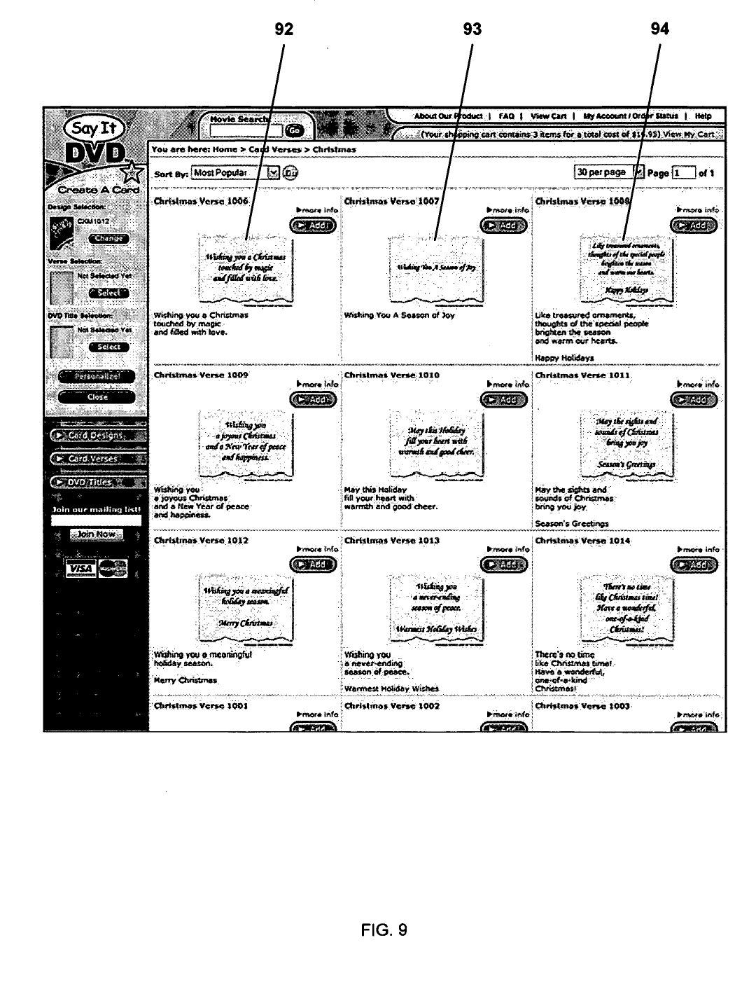

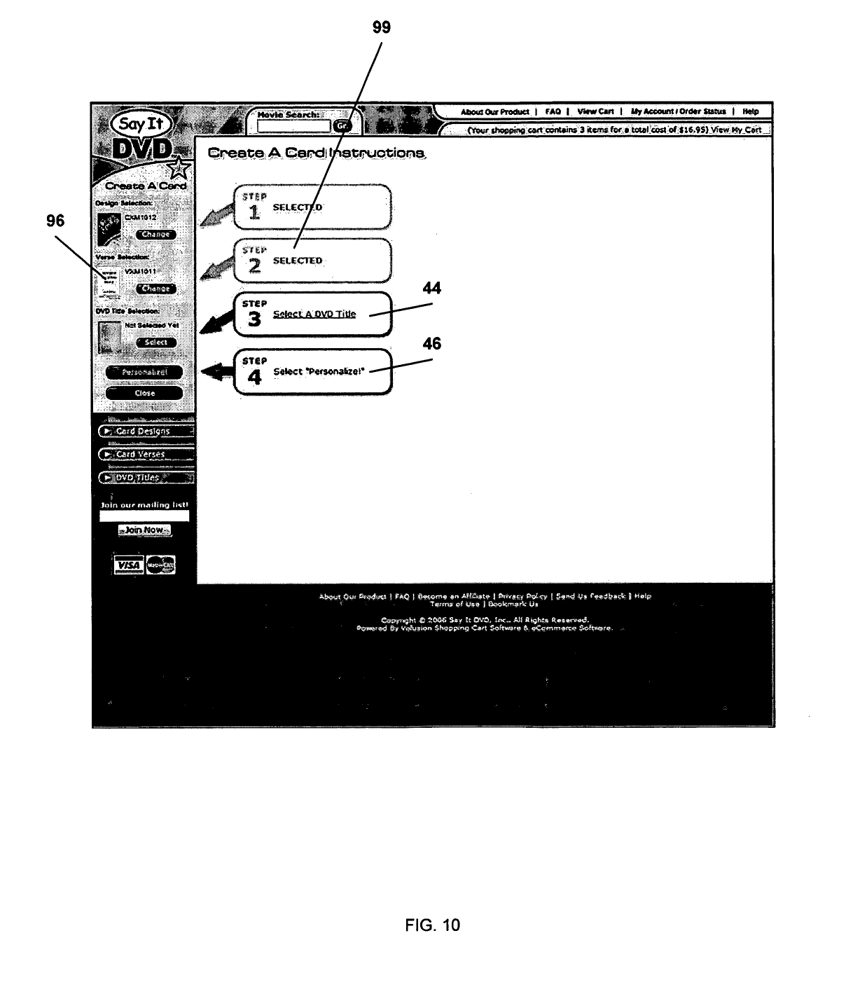

When a verse category is selected, as shown in FIG. 9; the user selects a verse, e.g. 92, 93, and 94, from a listing of the verses for that category. However, there is no limited to the number of verses in the vendor's database. When the user selects a verse FIG. 10, a thumbnail thereof is placed in the verse Selection slot 96 of the create-a-card wizard and is indicated as being selected in tab 99. The user's next step is to select a DVD title by clicking on tab 44.

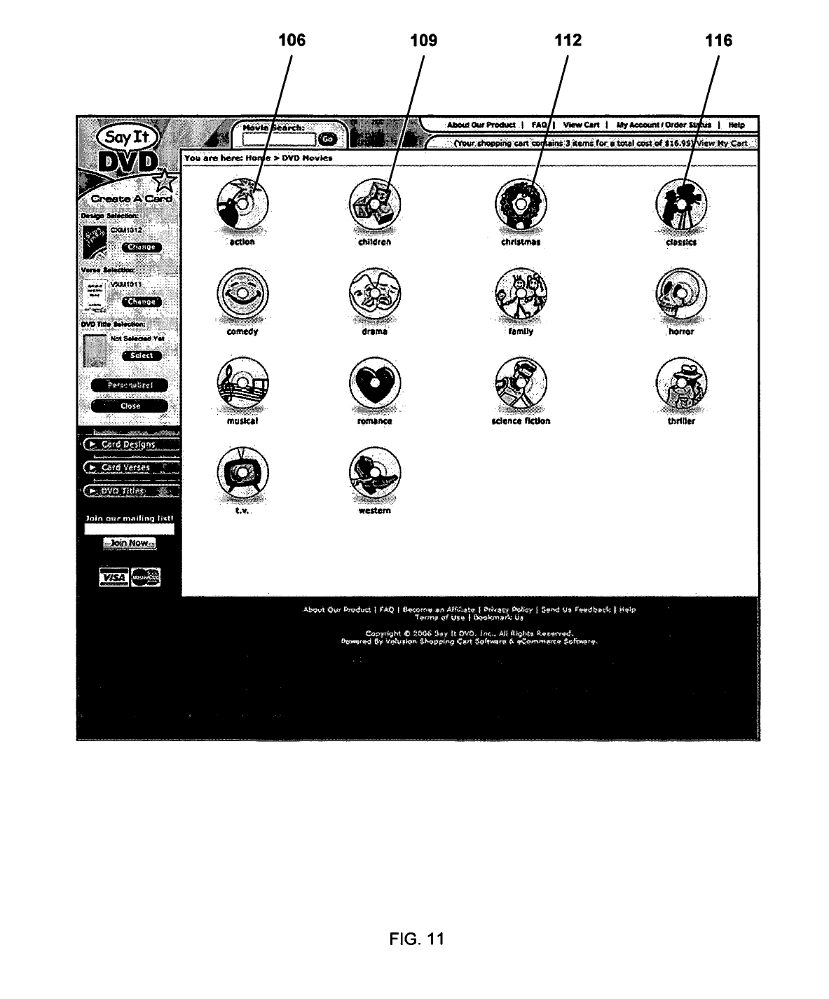

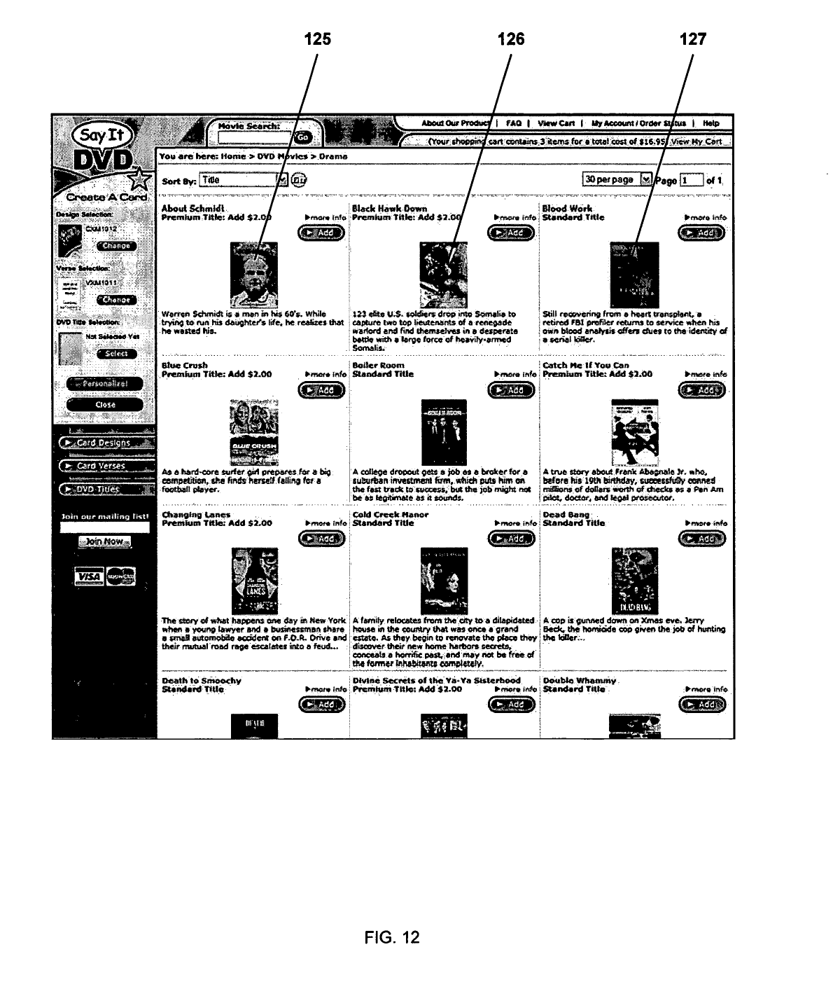

The network user selects from a list of categories (genres) of movie/entertainment DVD titles, as shown in FIG. 11, e.g. Action 106, Children 109, Christmas 112, Classics 116. However, there is no limited to the number of DVD title categories in a vendor's database. When the user selects a DVD title category, as shown in FIG. 12, a listing of DVD titles for that category is displayed. The user selects a DVD title, e.g. 125, 126, 127 from the listing of DVD titles. There is no limited to the number of DVD titles in the vendor's database.

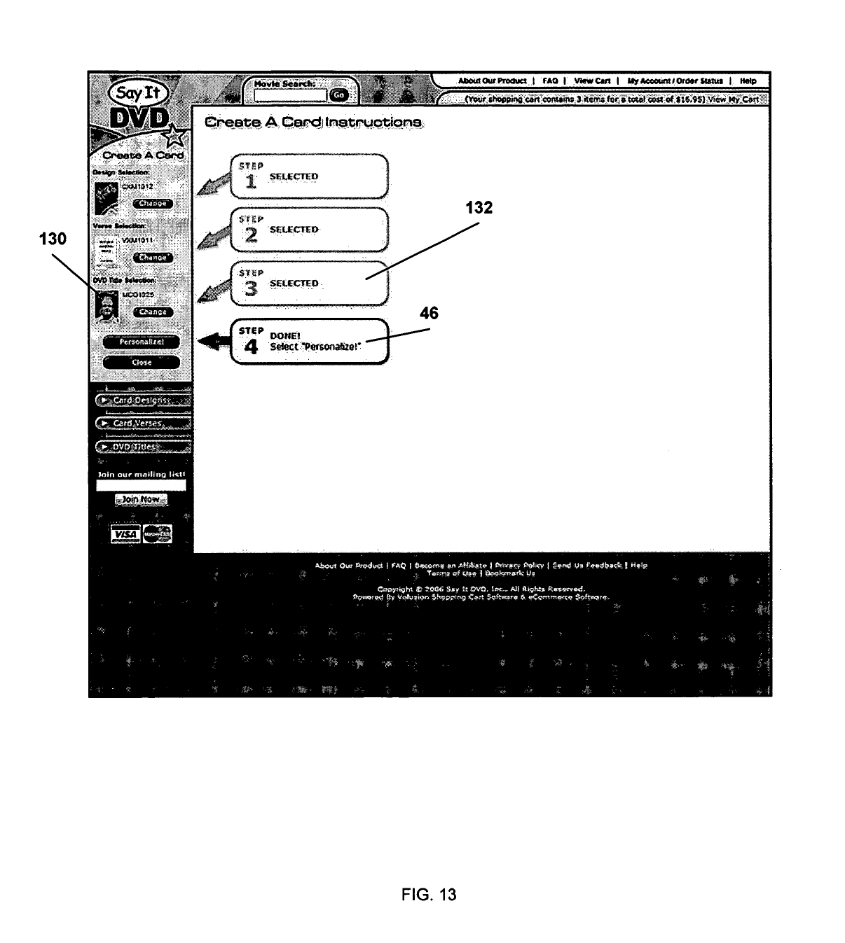

After the network user selects a DVD title, FIG. 13, a thumbnail of the cover art of the DVD title is placed in the DVD title selection slot 130 of the create-a-card wizard and is indicated as being selected at tab 132. The final step for the network user is to personalize the card, which is accomplished by clicking on tab 46 allowing the user to select font styles, add a photo and a write a closing greeting.

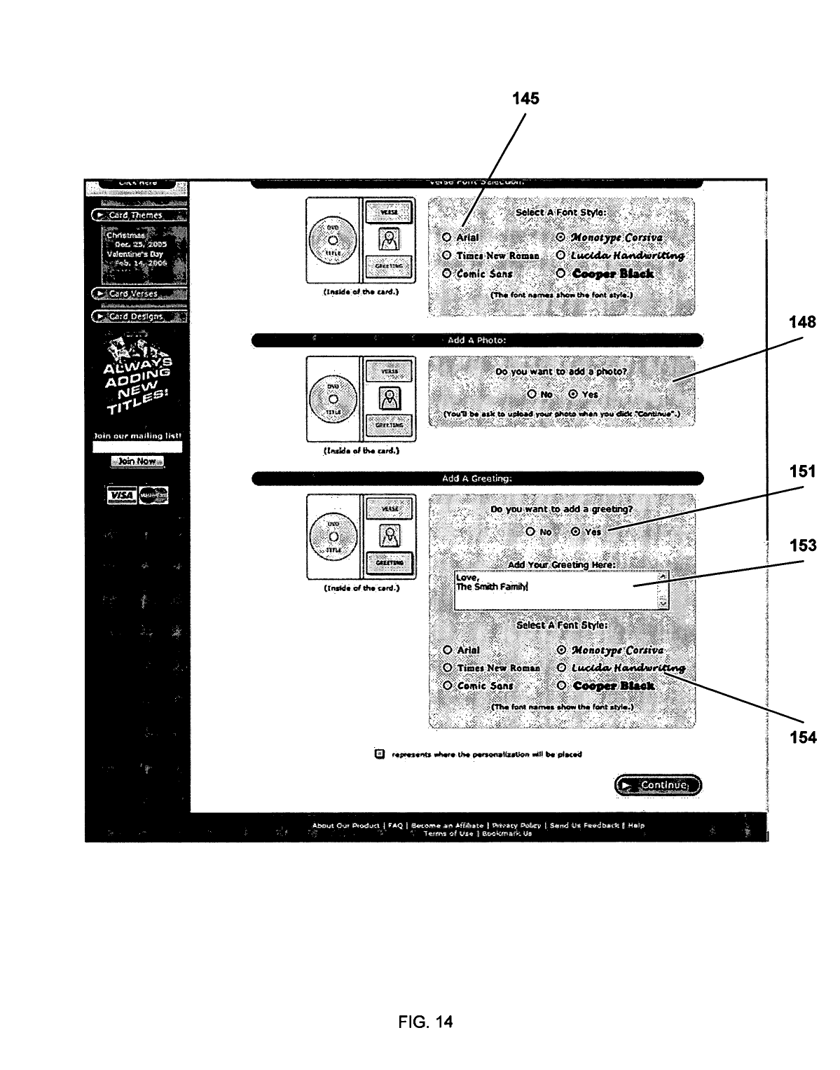

FIGS. 14-18 illustrate other web pages, in accordance with the inventive system, showing screen captures of the graphic user interface which involves the personalization portion of the greeting card, as would be displayed to a network user. In FIG. 14 the user can select the font style 145 for the verse they selected or written, option to add a photo 148, option to write a closing greeting 151, write a closing greeting 153, and to select the font style of the closing greeting 154.

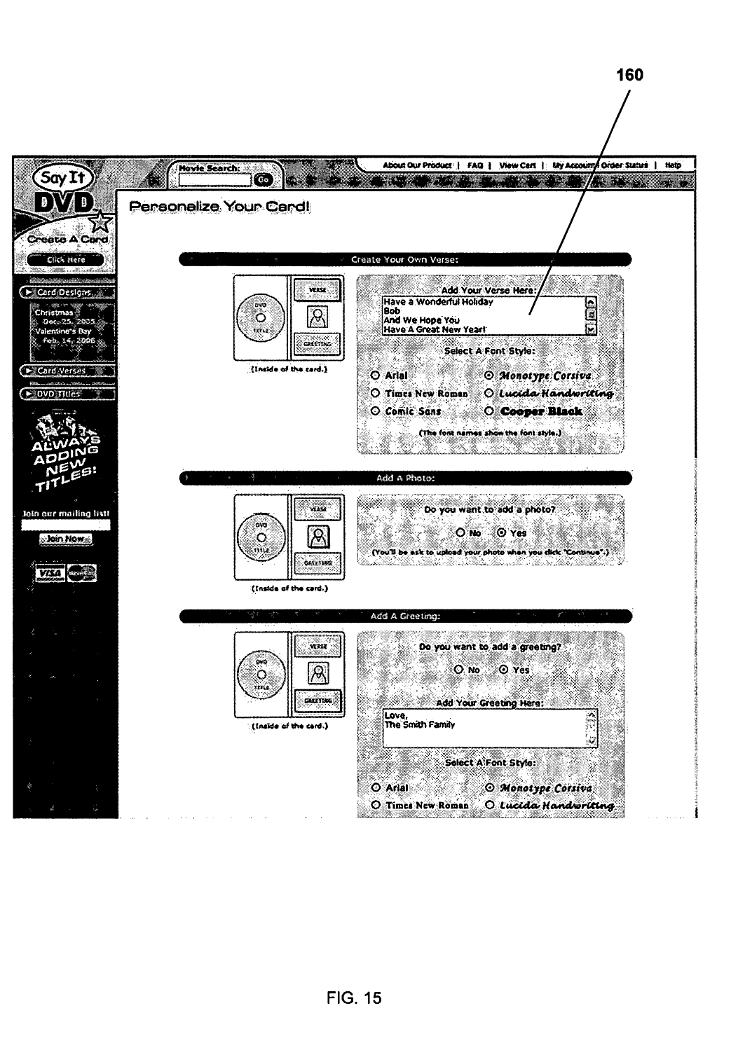

FIG. 15 is a screen capture of the graphic user interface of the inventive program illustrating the capability for users to write their own verse by typing same in the “create your own verse” dialog box 160.

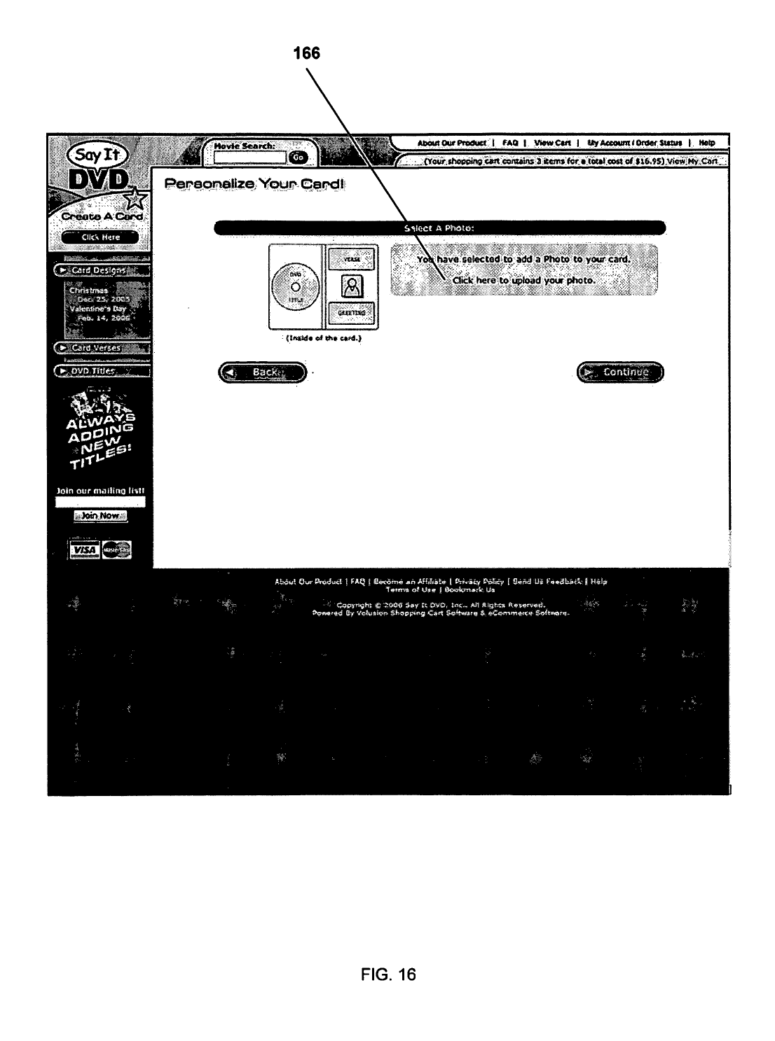

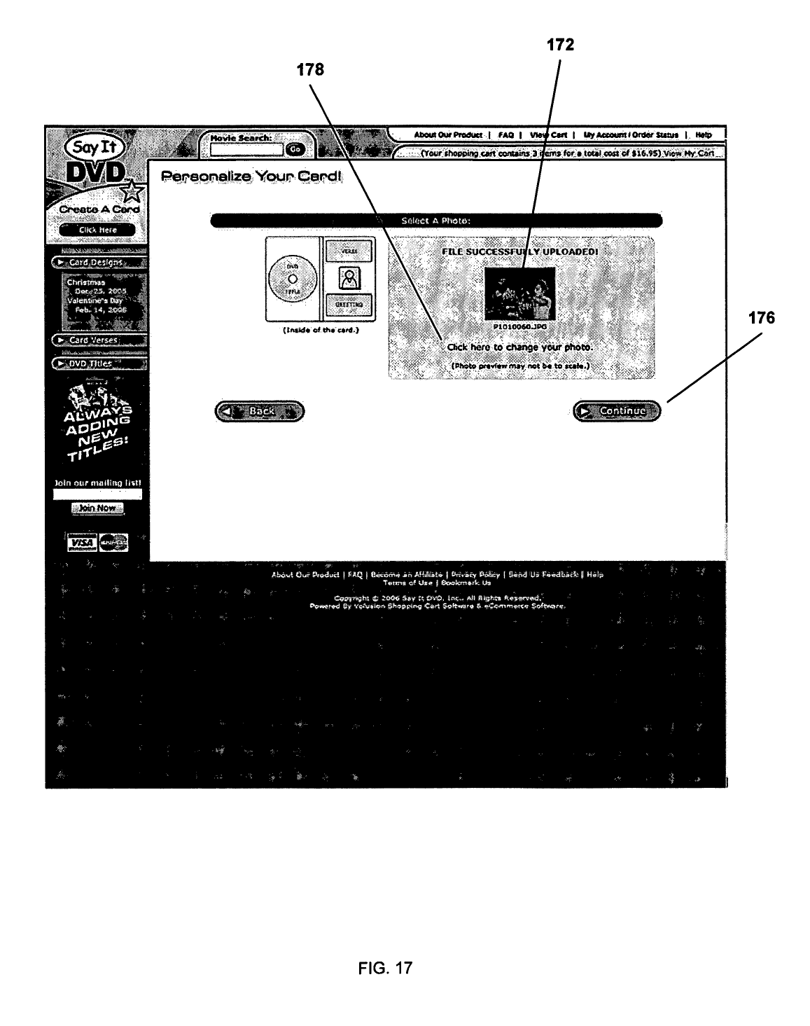

FIG. 16 is a screen capture of the graphic user interface of the inventive server illustrating the capability for users to add a photo clicking to upload a photo 166 from the user's computer, which is uploaded to the vendor's database and returned as a rendered thumbnail and displayed, as shown in FIG. 17, in the user's browser 172. Once viewed the user can accept the uploaded photo 176 or change the photo by clicking on the link 178.

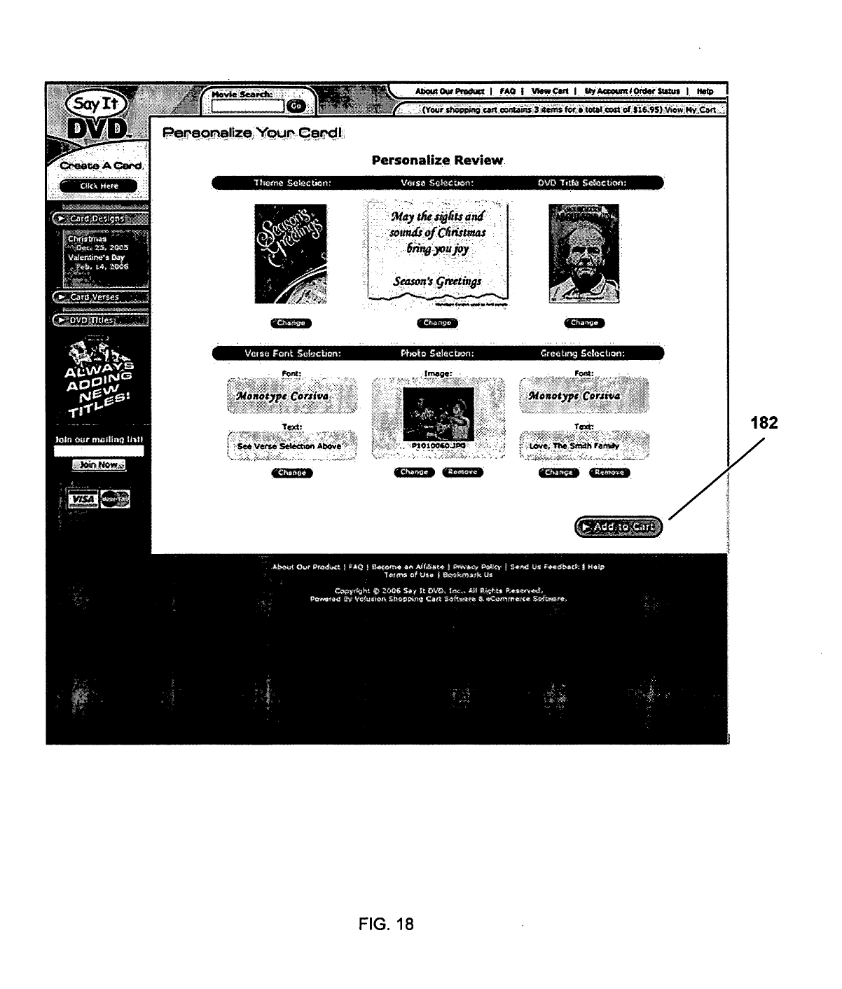

FIG. 18 is a screen capture of the graphic user interface of the inventive server illustrating all of the selected components for the custom card, for review. The network user can change any selected component. When user is satisfied with the custom card, they then add it to the shopping cart 182.

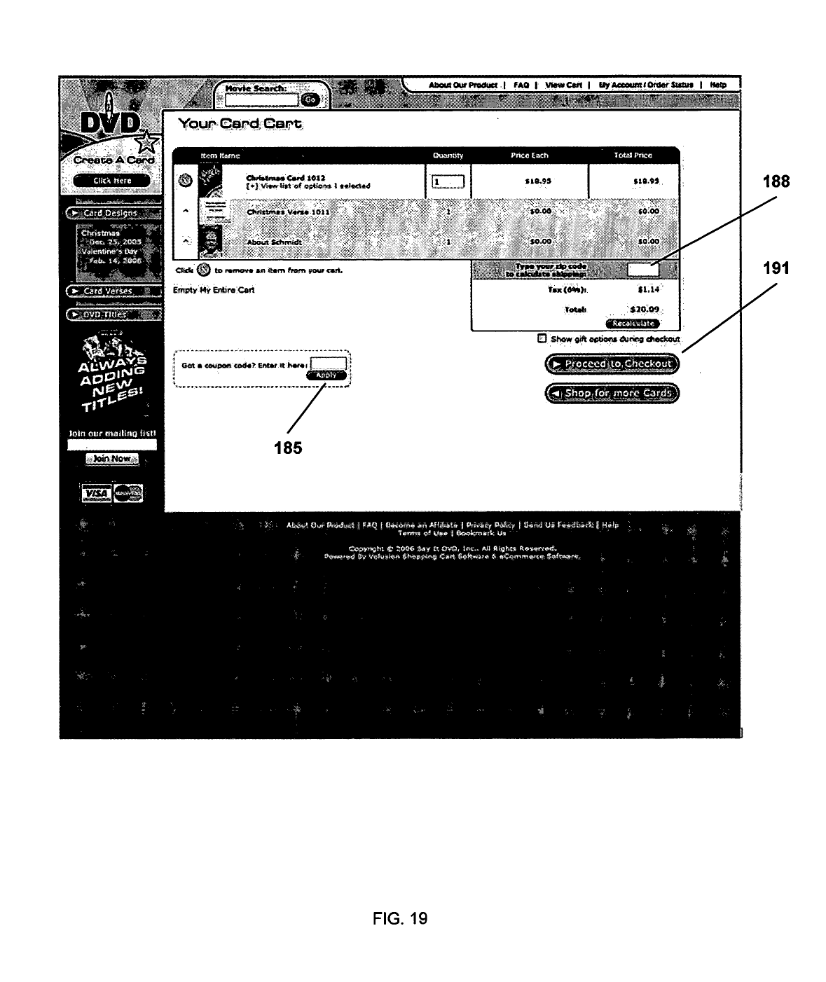

FIG. 19 is a screen capture of the graphic user interface of the inventive server illustrating the completed custom card added into a shopping cart. The user can add an optional coupon code 185, calculate shipping 188 and proceed to check out 191.

In all cases it is to be understood that the above described configurations are merely illustrative of the many possible specific embodiments which represent applications of the present invention. Numerous and varied other configurations can be readily devised in accordance with the principles of the present invention without departing from the spirit and scope of this invention.

What I claim is:

1. A multimedia greeting card which comprises a housing made up of a first panel hingedly connected to a second panel, media content stored on a DVD removably connected to one of the panels, a themed outer cover/sleeve over the housing covering at least a portion of the exterior of the housing, and one or more areas, or “fields”, associated with the housing in which one or more verbal greetings or messages, and/or photograph or other images, may be displayed.

2. A method of permitting users to create customized greeting cards, comprising the steps of:
a. providing, over a communications network, a plurality of general card theme (e.g. birthday, Valentine's Day, etc.) choices to a consumer;
b. receiving a selection of one of the themes from the consumer;
c. providing a plurality of thematic graphic selections to the consumer relating to the general theme chosen by the consumer;
d. receiving a selection of the thematic graphic from the consumer;
e. providing a list of media content choices stored on DVD to the consumer;
f. receiving a selection of media content from the consumer;
g. providing a list of text message choices, including an option for creating a custom message;
h. receiving a selection of a text message from the consumer;
i. providing a list of verse choices to the consumer;
j. receiving a selection of a verse from the consumer;
k. providing a list of photographic/graphical image choices to the consumer;
l. receiving a selection of a photographic/graphic image from the consumer;
m. assembling the selected thematic graphic matter onto an outer cover/sleeve of the housing, the selected media content stored on a DVD onto a DVD disc holder associated with one of the housing panels, and the verse, textual and photographic/graphic matter into a completed multimedia greeting card.

3. A method of permitting consumers to create customized multimedia greeting cards, comprising the steps of:
a. providing, over a communications network, a plurality of thematic graphic choices to the consumer;
b. receiving a selection of the thematic graphic from the consumer;
c. providing a list of DVD media content selections to the consumer;
d. receiving, from the consumer, a DVD media content selection;
e. assembling the selected thematic graphic choice and DVD media content onto a DVD housing to thereby create a completed customized multimedia greeting card, and delivering the customized multimedia greeting card to the consumer or other recipient designated by the consumer.

4. The method of permitting consumers to create customized multimedia greeting cards as set forth in claim 3, further comprising the steps of:
a. providing, over a communications network, a plurality of general card theme (e.g. birthday, Valentine's Day, etc.) choices to a consumer;
b. receiving a selection of one of the themes from the consumer.

5. The method of permitting consumers to create customized multimedia greeting cards as set forth in claim 3, further comprising the steps of:
a. providing a list of text message choices, including an option for creating a custom message, to the consumer;
b. receiving a selection of a text message from the consumer.

6. The method of permitting consumers to create customized multimedia greeting cards as set forth in claim 3, further comprising the steps of:
a. providing a list of verse choices to the consumer;
b. receiving a selection of a verse from the consumer.

7. The method of permitting consumers to create customized multimedia greeting cards as set forth in claim 3, further comprising the steps of:
a. providing a list of photographic/graphical image choices to the consumer;
b. receiving a selection of a photographic/graphic image from the consumer.

8. The method of permitting consumers to create customized multimedia greeting cards as set forth in claim 3, further comprising the step of assembling a sheet of printed media content information onto the DVD housing prior to delivering the multimedia greeting card to the consumer or other recipient designated by the consumer.
